(19) United States
(12) Patent Application Publication
(10) Pub. No.: US 2017/0122157 A1
(43) Pub. Date: May 4, 2017

(54) DPF Cleaning Process Using a Temporary Plug

(71) Applicant: Caterpillar Inc., Peoria, IL (US)

(72) Inventor: Sean O. Cornell, Gridley, IL (US)

(73) Assignee: Caterpillar Inc., Peoria, IL (US)

(21) Appl. No.: 15/196,728

(22) Filed: Jun. 29, 2016

Related U.S. Application Data
(63) Continuation-in-part of application No. 14/925,275, filed on Oct. 28, 2015.

(51) Int. Cl. F01N 3/023; F01N 3/035; F01N 3/20; B01D 46/00

(52) U.S. Cl. CPC F01N 3/0233; B01D 46/0063; B01D 46/0064; F01N 3/035; F01N 3/2066; F01N 3/0232

(57) ABSTRACT

A method of removing or reducing the particulate buildup within the diesel particulate filter of an aftertreatment system includes the selective application of a blocking agent to a filter medium of the diesel particulate filter, displacement of the particulate from the filter medium using a fluid stream, and subsequent removal of the blocking agent.

### CROSS REFERENCE TO RELATED APPLICATIONS

This application is a Continuation-In-Part of U.S. patent application Ser. No. 14/925,275, filed Oct. 28, 2015.

### TECHNICAL FIELD

The disclosure relates generally to methods of cleaning internal combustion engine components, and more particularly to methods of removing particulate accumulated on diesel particulate filters.

### BACKGROUND

Fuel combustion in an internal combustion engine system generally emits a complex mixture of chemical species in its exhaust streams. The emissions from these engines may include organic and inorganic particulate matter such as soot, sulfates, soluble organic fraction, and ash. To reduce the levels of these chemical species in an engine's emissions, combustion engine systems incorporate aftertreatment systems. A diesel particulate filter (DPF) represents one component of an aftertreatment system for removing and/or reducing the diesel particulate matter from an exhaust stream. The DPF may be used to trap these particulate matters generated from combustion, thereby limiting the amount of soot and other particulate matter that is emitted into the environment.

A typical DPF may include a porous or permeable substrate, which may be coated with various chemical compounds that alter a composition of exhaust contents. The porous substrate of the filter physically traps carbon particles or soot as the exhaust stream passes over and/or through the DPF. With time, the particulate matter begins to accumulate in the DPF. This accumulation may inhibit air flow from the engine through the exhaust stream, which may ultimately harm engine efficiency.

Typically, a diesel particulate filter must be periodically regenerated in order to reduce back pressure on the engine and/or to prevent a runaway exothermic soot oxidation reaction in a soot load trapped in the filter. Reducing back pressure on the engine is generally associated with more efficient operation, and hence an incremental reduction in fuel consumption by the engine. A runaway exothermic oxidation reaction is generally undesirable since temperatures can become briefly so high that the filter substrate (e.g., zeolite) may become cracked or otherwise damaged to the point that the filter may be compromised. Active regeneration of a diesel particulate filter refers to a process by which the accumulated soot in the diesel particulate filter is oxidized by increasing the temperature at the filter in order to encourage soot oxidation. The active regeneration process is sometimes carried out with fuel injected into an aftertreatment system upstream from the diesel particulate filter, by the use of electrical heaters or the like.

Unlike soot, the ash particulate is generally not susceptible to typical filter regeneration processes, as the ash is non-combustible. Often the ash particulate includes metallic elements and inorganic compounds originating from additives present in the lubricating engine oil. Particles of metal oxides are formed as a result of the combustion initiated oxidation of the metallic elements and inorganic compounds during normal engine operation. These particles may then travel through the engine system into the aftertreatment system where they can collect on, and obstruct, the diesel particulate filter. Conventionally, this ash layer is considered troublesome in that the ash blocks the filter, causing increased back pressure to the engine thereby increasing fuel consumption and decreasing power.

Conventional cleaning methods for removing this remaining particulate accumulation can employ a pressurized air stream, or a pneumatic air knife as presented in U.S. Pat. No. 8,568,536. However, this particular approach may be less satisfactory because the accumulated particulate may not be sufficiently displaced by the pressurized air. Accordingly, the disclosure provides a method of effectively displacing particulate from a diesel particulate filter where the particulate has not been removed by conventional cleaning methods. The methods of the present disclosure utilize a blocking agent at the filter to generate sufficient force for a fluid to sufficiently displace particulate that was unmoved by conventional cleaning methods.

### SUMMARY

The disclosure is directed to a method for removing particulate matter from a diesel particulate filter (DPF) of an internal combustion engine. In one aspect, a method of removing particulate from a DPF with an exhaust inlet end and an exhaust outlet end may include disposing a blocking agent within the filter adjacent the exhaust outlet end of the filter medium of the diesel particulate filter, directing a stream of pressurized fluid into the exhaust outlet end of the diesel particulate filter to force pressurized fluid and the particulate to flow out of the exhaust inlet end, and removing the blocking agent.

In a further aspect, a method of removing particulate from a diesel particulate filter having an exhaust outlet side, an exhaust inlet side, and a filter medium having axially oriented, parallel exhaust inlet channels and exhaust outlet channels defined by permeable channel walls, the inlet channels and outlet channels each alternately having a non-permeable wall disposed at an end thereof may include inserting a blocking agent into the outlet channels adjacent the outlet side non-permeable wall to direct fluid passage through the filter medium from the outlet side to the inlet side of the filter medium, directing a stream of pressurized fluid through the outlet side of the filter medium to force the pressurized fluid and the particulate out the inlet side of the filter, and removing the blocking agent from the outlet channels.

### BRIEF DESCRIPTION OF THE DRAWINGS

FIG. 1 is a schematic view of an aftertreatment system of an internal combustion engine including a diesel particulate filter according to aspects of the disclosure.

FIG. 2 is a partial sectioned cross-sectional view of a diesel particulate filter according to aspects of the disclosure.

FIG. 3 is a schematic for the passage of an engine exhaust stream through a diesel particulate filter according to aspects of the disclosure.

FIG. 4 is a partial sectioned cross-sectional view of a diesel particulate filter with particulate buildup according to aspects of the disclosure.

FIG. 5 is a schematic for the passage of an engine exhaust stream through a diesel particulate filter and selectively applied blocking agent according to aspects of the disclosure.

FIG. 6 is a partial sectioned cross-sectional view of a diesel particulate filter with particulate buildup and selectively applied blocking agent according to aspects of the disclosure.

FIG. 7 is a partial sectioned cross-sectional view of a diesel particulate filter with particulate buildup and pneumatic air flow according to aspects of the disclosure.

FIG. 8 is a flowchart of a method according to aspects of the disclosure.

FIG. 9 is a schematic for the passage of an engine exhaust stream through a diesel particulate filter and selectively applied blocking agent according to aspects of the disclosure.

### DETAILED DESCRIPTION

This disclosure relates to a system and method of removing particulate that has accumulated in a DPF by using a blocking agent. According to various aspects of the methods disclosed herein, a blocking agent may be selectively applied at a filter medium of the DPF. DPF particulate removal procedures employing a pneumatic air knife may be used to displace the particulate. As such, the blocking agent may block the air flow of the air knife and thus redirect and focus the air flow to the areas of the DPF filter wall that have not been blocked. After particulate displacement, the blocking agent may be removed.

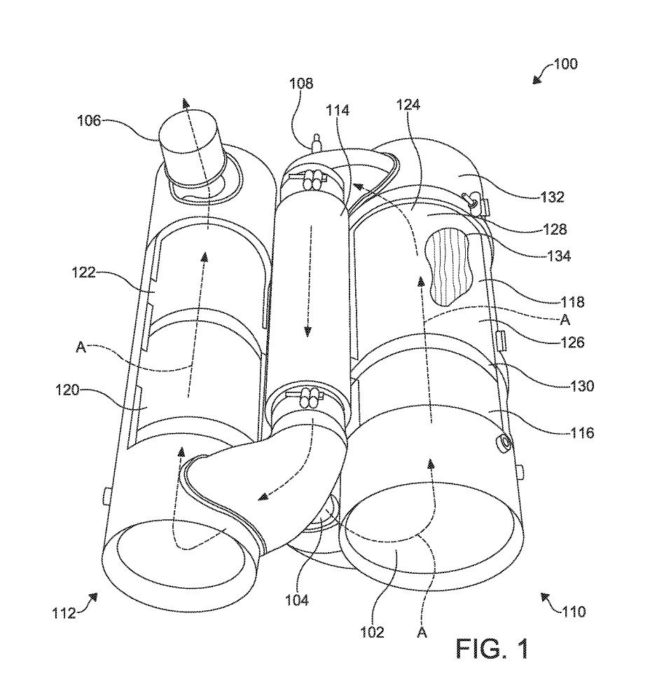

As shown in FIG. 1, an aftertreatment system 100 may be configured to limit or remove particulate matter from an engine exhaust stream 102. The aftertreatment system 100 may include a system inlet 104 for an engine exhaust stream 102 from a combustion engine (not shown), a system outlet 106, a reductant supply 108, a first housing 110, and a second housing 112. The system inlet 104 may deliver the engine exhaust stream 102 into the first housing 110. The first housing 110 may be in fluid communication with the second housing 112 via intermediate tubing 114, which may also fluidly connect to the reductant supply 108. The first housing 110 may include a diesel oxidation catalyst (DOC) 116 and a diesel particulate filter (DPF) 118 including a filter medium 134. The second housing 112 may include a selective catalytic reduction (SCR) catalyst 120 and an ammonia oxidation (AMOX) catalyst 122. As indicated by arrows “A” in FIG. 1, the engine exhaust stream 102 may travel through the system inlet 104 into the first housing 110 and pass through the DOC 116. The DOC 116 may be configured to facilitate the chemical oxidation of the contents of the engine exhaust stream 102 such as, but not limited to, carbon monoxide, hydrocarbons, and the organic fraction of diesel particulates (SOF).

From the DOC 116, the engine exhaust stream 102 may travel through the DPF 118 for particulate filtering to the intermediate tubing 114 for passage to the second housing 112 of the aftertreatment system 100. A reductant (e.g., urea, diesel exhaust fluid, or the like) supply 108 may be in fluid communication with the housings 110, 112 of the aftertreatment system 100 at the intermediate tubing 114. The reductant supply 108 may deliver a desired reductant into the engine exhaust stream 102 upstream from the DPF 118 as the engine exhaust stream 102 passes through to the second housing 112 including the SCR catalyst 120 and AMOX catalyst 122. Generally, the SCR catalyst 120 may chemically reduce nitrous oxides in the engine exhaust stream 102 to elemental nitrogen, while the AMOX catalyst 122 may be configured to reduce amounts of unreacted ammonia as the engine exhaust stream 102 departs the aftertreatment system 100 via the system outlet 106.

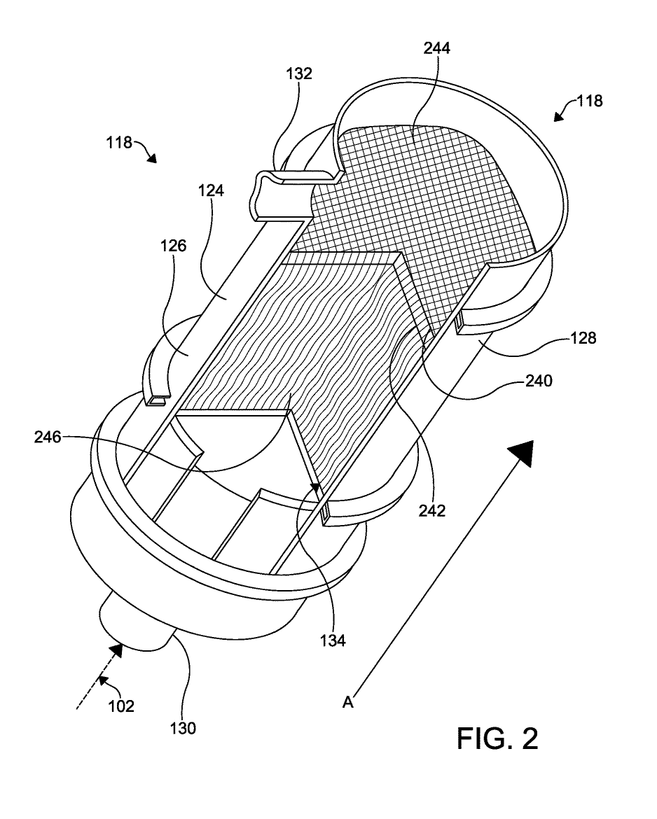

Referring to FIG. 2, the DPF 118 may include a filter body 124 having a cylindrical shape. However, other shapes and sizes may be used. The filter body 124 may be of any suitable size, for example, a volumetric space velocity less than 70,000/hr corresponding to exhaust flow at a rated condition divided by the volume of the filter. The volumetric space velocity may refer to the quotient of the volumetric flow rate of the entering engine exhaust stream 102 divided by the DPF 118 volume. As such, the space velocity may indicate the number of reactor volumes that can be treated per unit time, such as for example, 70,000/hr. The filter body 124 may be formed from a metal resistant to corrosion or rusting, such as stainless steel. The filter body 124 may also include a filter inlet 130 disposed at a first axial end 126 of the filter body 124. The filter inlet 130 may be configured to receive the engine exhaust stream 102 entering the DPF 118. A filter outlet 132 may be disposed at a second axial end 128 of the filter body 124 for the engine exhaust stream 102 exiting the DPF 118.

The filter body 124 may include a filter wall 240 disposed adjacent the filter medium 134. As used herein, adjacent the filter wall 240 may mean that that the filter wall 240 is abutting or spaced from the filter medium 134, or is defined by at least a portion of the filter medium 134. Further, adjacent may even include an intervening retainer or other element disposed between the filter medium 134 and the filter wall 240. In one configuration, the filter wall 240 may include or may be formed from the filter medium 134. The filter wall 240 may have an outlet side 244 oriented towards the filter outlet 132. In a further configuration, a structure independent from the filter medium 134 may form the filter wall 240. The structure defining the filter wall 240 may include a retainer or other element. The retainer or other element may be disposed adjacent an end of the filter medium 134. In some aspects, the filter wall 240 may have an inlet side 242 oriented towards the filter medium 134 and an outlet side 244 oriented towards the filter outlet 132.

In a further aspect, the filter body 124 may house a filter medium 134 configured to separate particulate matter from the engine exhaust stream 102. The filter medium 134 may include a porous substrate 246 to facilitate this separation by collecting the particulate matter from the engine exhaust stream 102. In an example, the porous substrate 246 may be ceramic. In a further example, the filter medium 134 of the DPF 118 may be of any suitable construction, such as a zeolite wall flow porous substrate 246 of a type well known in the art. Other porous substrates 246 may include, but are not limited to, vanadia or titania. In certain aspects of the present disclosure, the porous substrate 246 may include tubular elements sized to collect particulate. In one example, the filter medium 134 may include a collection of filter elements arranged in bundles. Each filter element may have an essentially tubular shape and polygonal cross section, such as for example, a hexagonal or octagonal cross-section. These filter elements are typically grouped together into a larger, cylindrically-shaped filter medium 134, for example, having a beehive cross-sectional shape. The filter elements may provide a relatively large surface area onto which particulate matter such as soot and ash can collect.

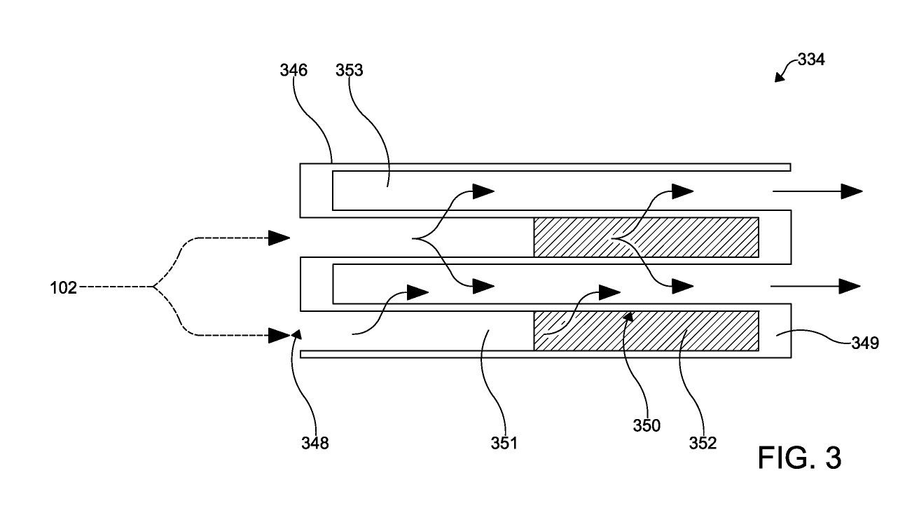

In a yet further aspect, as shown in FIG. 3, the DPF 118 may include a porous substrate 346 of a filter medium 334, which may include a plurality of adjacent, axially oriented parallel channels 348 defined by permeable channel walls 350. These adjacent channels 348 of the filter medium 334 may be obstructed at an end thereby forming a non-permeable wall 349. The non-permeable wall 349 may occur in alternating parallel channels 348 rather than adjacent parallel channels 348. A channel 348 having its non-permeable wall 349 situated towards the second axial end 128 of the DPF is an inlet channel 351. During normal operation of the diesel engine, an inlet channel 351 may receive the engine exhaust stream 102 entering the filter medium 334 of the DPF 118. A channel 348 having its non-permeable wall 349 situated towards the first axial end 126 of the DPF may be considered an outlet channel 353. The non-permeable wall 349 may force the engine exhaust stream 102 to flow through the permeable channel walls 350 rather than flowing through the channel 348 itself, which in turn may provide the filtering mechanism to separate particulate from the engine exhaust stream 102.

In one aspect of the present disclosure the DPF 118 filters particulate present in the engine exhaust stream 102 flowing through the DPF 118. With the filtering process, particulate 352 may collect in the filter medium 334. That is, during normal operation of an internal combustion engine, the engine exhaust stream 102 may flow into an inlet channel 351 of the filter medium 334. The non-permeable wall 349 of the inlet channel 351 may force the engine exhaust stream 102 to flow through the permeable channel wall 350 of the filter medium 334 and into an adjacent outlet channel 353. The motion of the engine exhaust stream 102 traveling through the permeable channel wall 350 generates the filtering mechanism which may separate any particulate 352 from the engine exhaust stream 102. As such, particulate 352 may collect within the inlet channel 351 building up towards the non-permeable wall 349, while the engine exhaust stream flows into the outlet channel 353 towards the filter outlet 132.

As noted herein and with reference to FIGS. 2 and 3, this particulate 352 may include soot, ash and other organic and inorganic matter particulate. Under normal operating conditions, the engine exhaust stream 102 enters the DPF 118 at the first axial end 126, passes through the filter medium 134 where particulate 352 may be deposited, for example within the inlet channels 351, and exits the DPF 118 at the second axial end 128 through the filter outlet 132. The deposited particulate 352 may accumulate over time, thereby hindering filter efficiency. In general, the particulate 352 accumulating within the filter medium 134 of the DPF 118 may be removed periodically by a filter regeneration process. This regeneration process may often employ the use of a heat source (not shown) to oxidize or combust the particulate 352. The combustion process, or filter regeneration process, can readily remove particulate 352 comprising soot but particulate comprising ash is not so readily removed via combustion. The particulate 352 comprising ash or other inorganic matter particulate, which builds up as a result of burning lubrication oil in the engine, may thus continue to accumulate with regular operation of the engine. As such, the particulate 352 in the DPF 118 that is not readily removed via combustion may compound upon itself. This particulate 352 can diminish the surface area for flow of the engine exhaust stream 102 through the DPF 118 and ultimately increase exhaust gas restriction of the engine and fuel consumption. Various aspects of the methods disclosed herein are thus configured to achieve the removal of the remaining particulate 352 in the DPF 118 that may not have been readily removed via combustion methods.

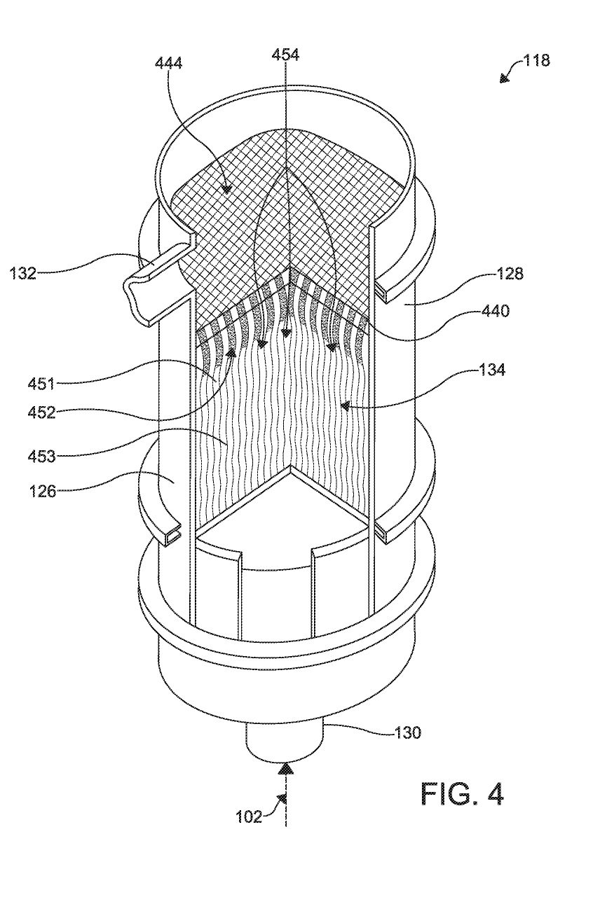

As shown in FIG. 3, the particulate 352 can create blockages in the filter medium 134 of the DPF 118. Over time, the particulate 352 can form a wall or column of buildup impeding the flow of the engine exhaust stream 102 through the DPF 118 from the first axial end 126 to the second axial end 128. Turning to FIG. 4, in a conventional method of removal, the DPF 118 may be positioned with the DPF 118 in an upright vertical position having the first axial end 126 oriented downwards in the direction of gravity. To remove the particulate 452, a pressurized air stream 454 may be directed at the outlet side 444 of the filter wall 440 to flow through a portion of the parallel channels 451, 453 of the filter medium 134 from the second axial end 128 to the first axial end 126 of the DPF 418. The accumulated particulate 452 and air are generally forced out through the first axial end 126 towards the filter inlet 130. However, given the formation of particulate 452 buildup within the filter medium 134, the pressurized air stream 454 may fail to dislodge the particulate 452. The entering pressurized air stream may instead flow around the accumulated particulate 452. The pressurized air stream 454 may use the path of least resistance by flowing around the particulate 452 and is thus less effective in dislodging the particulate 452. The methods disclosed herein are configured to facilitate the removal of this remaining particulate 452 that has not been removed by a combustion or filter regeneration processes.

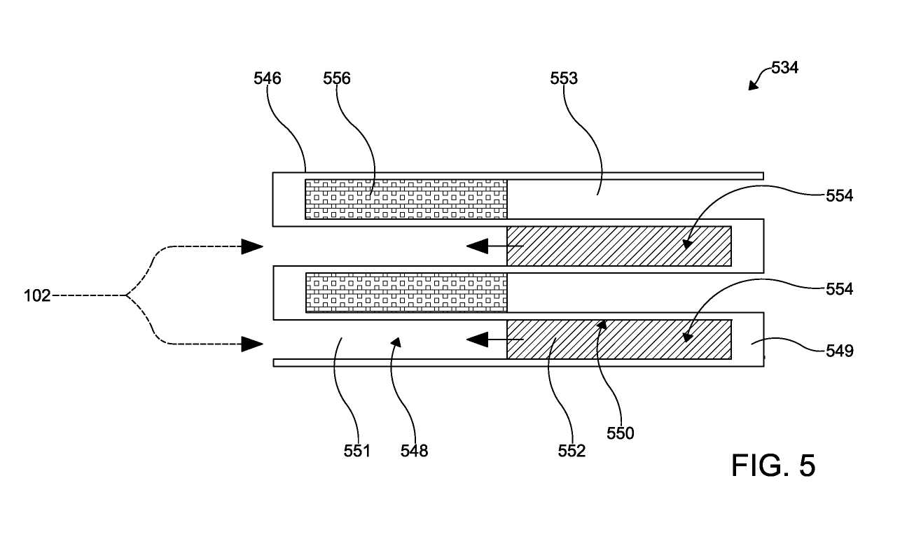

An exemplary aspect of a method for removing particulate 552 buildup of a DPF 518 is exemplified in the illustration of a partial cross section of a DPF 518 in FIG. 5 showing channels 548. According to the methods disclosed herein, a blocking agent 556 may be disposed within the filter medium 534 of the DPF 518. As an example, the blocking agent 556 may be selectively applied to portions of the filter medium 540 without particulate 552 buildup. That is, the blocking agent 556 may be selectively placed at portions of the filter medium for which there are no walls or columns of particulate 552 accumulated in the filter medium 534. As an example, the blocking agent 556 may be disposed within the outlet channels 553 of the filter medium 534. The blocking agent 556 may be selectively disposed such that the amount of blocking agent 556 introduced to an outlet channel 553 is sufficient to reach the physical distance of the amount of particulate 552 that has accumulated in the inlet channel 551 adjacent the outlet channel 353 of the filter medium 534.

In various aspects, the blocking agent 556 may be selected so as to effectively obstruct fluid passage through the filter medium 534. Thus, an exemplary blocking agent 556 according to the methods disclosed herein may include materials that cannot readily flow through the permeable channel walls 550 of the filter medium 534 of the DPF 518. These materials may be unable to permeate the filter medium 534 owing to inherent characteristics of the material. For example, the materials may not readily flow through the filter medium 534 because of the average particle size of the material. In a further example, the blocking agent 556 may be too viscous to allow passage through the filter medium 534. As such, the blocking agent 556 may be applied to the filter medium in a manner to effectively block the desired portion of the filter medium 534. For example, the blocking agent 556 may be applied in discrete layers over a desired portion of the filter medium 534. The use of multiple discrete layers of the blocking agent may be employed to achieve blockage of fluid passage through the filter medium 534.

In a specific aspect, the blocking agent 556 may be a solid media. The solid media may be disposed within the filter medium 534 so as to obstruct passage fluid passage through the filter medium 534. In an aspect, the solid media may have an average particle size that may prevent fluid passage through the filter medium 534. In further aspects, the solid media may be disposed within the filter medium 534 in such an amount that the addition of the solid media blocks the flow of fluid passage through the filter medium 534. For example, and not to be limiting suitable solid media blocking 556 agents may include sand, steel shot, and glass beads. Additional solid media blocking agents 556 may include water soluble powders. For example, the water soluble powder may including baking soda and other soluble salts.

In a particular example, soot may be an appropriate blocking agent 556 comprising a solid media. As an example, soot may have an average particle size that is generally too large to allow passage through the filter medium 534. This larger particle size may also contribute to why soot may accumulate within the filter medium 534. The soot blocking agent 556 may be applied to portions of the filter medium 534 in discrete layers. In one example, the thickness of the layer of soot may be so configured to block portions of the filter medium 534.

In a further aspect, the blocking agent 556 may include a viscous material. It is the viscosity of the blocking agent 556 that may prevent the blocking agent 556 from readily passing through the filter medium 534. The blocking agent 556 may include a viscous material. An exemplary viscous material may include a viscous resin, such as shellac. As one skilled in the art might appreciate, shellac and similarly viscous materials exhibit greater resistance to gradual deformation by stress or force on the material. As such, the stress resistance of viscous materials may tend to prevent the flow of the material through the filter medium 534 of the DPF 518. As an example, the viscous material may resist passage through the porous substrate 546 of the filter medium 534.

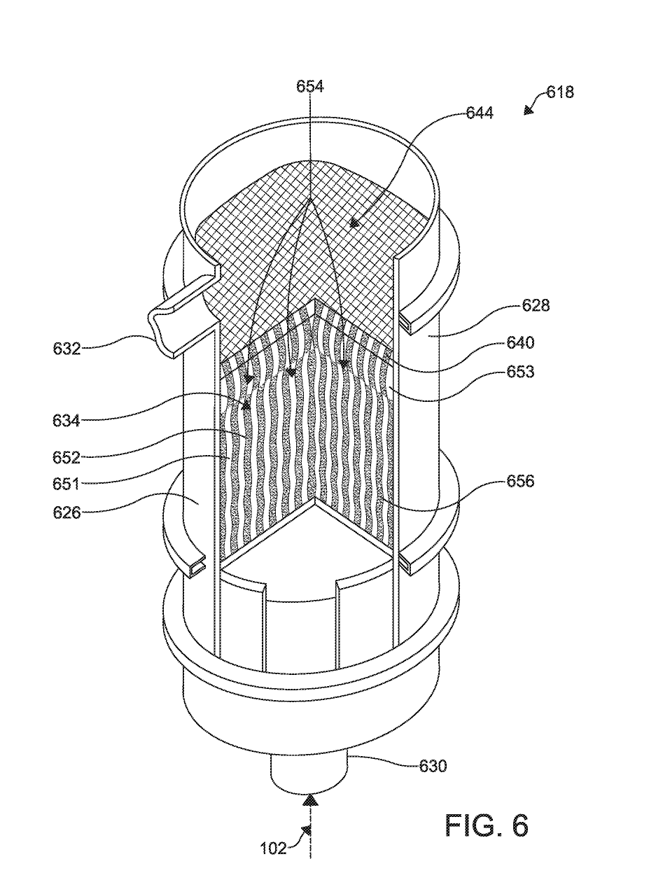

Turning to FIG. 6, in some aspects of the present disclosure, once the blocking agent 656 is applied at the filter medium 634, a fluid stream may be directed into the unblocked areas of the filter medium 634 to displace particulate 652 accumulated therein. As noted, use of a fluid stream, such as an air stream, may be a preliminary measure to remove or displace particulate from the DPF 618 prior to application of the blocking agent 656. However, the application of the blocking agent 656 may be used to facilitate displacement of particulate 652 from the DPF 618 after a fluid stream has been applied. In one example, a pressurized air stream 654 can be applied to portions of the outlet side 644 of the filter wall 640 into the areas of the filter medium 634 at which the blocking agent 656 has not been applied. The pressurized air stream 654 may be directed from the second axial end 628 of the DPF 618 at the outlet side 644 of the filter wall 640 to dislodge the accumulated particulate 652 from the filter medium 634. As shown in FIG. 6, disposing the blocking agent 656 at selected portions of the filter medium 634 may focus the pressurized air stream 654 to the parallel channels 651, 653 of the filter medium 634 that contain the accumulated particulate 652. In one aspect, the pressurized air stream 654, may be directed from the second axial end 628 towards the first axial end 626 into the portions of the filter medium 634 at which the blocking agent 656 has not been applied. In an example, where the blocking agent 556 may be selectively disposed within the outlet channels 553 of the filter medium 634, the pressurized air stream 654 may be directed into the outlet channel 653 of the filter medium. The blocking agent 656 may be selectively disposed such that the amount of blocking agent 656 introduced to an outlet channel 653 is sufficient to span the physical distance corresponding to the amount of particulate 652 that has accumulated in the adjacent inlet channel 651 of the filter medium 534. As such, when the pressurized air stream 654 is directed into the outlet channel 653, the blocking agent 656 may focus the pressurized air stream 554 through the permeable channel wall 650 into the adjacent inlet channel 651 of the filter medium 634. The force of the pressurized air stream 554 may thus dislodge the accumulated particulate 652 from the adjacent inlet channel 651.

In yet further aspects of the present disclosure, the pressurized air stream 654 represents only one example of a means of displacing the accumulated particulate 652 including ash. Other appropriate displacement mechanisms may include an effluent flush of the DPF 618. A suitable effluent may include water, such as a pressurized water flow.

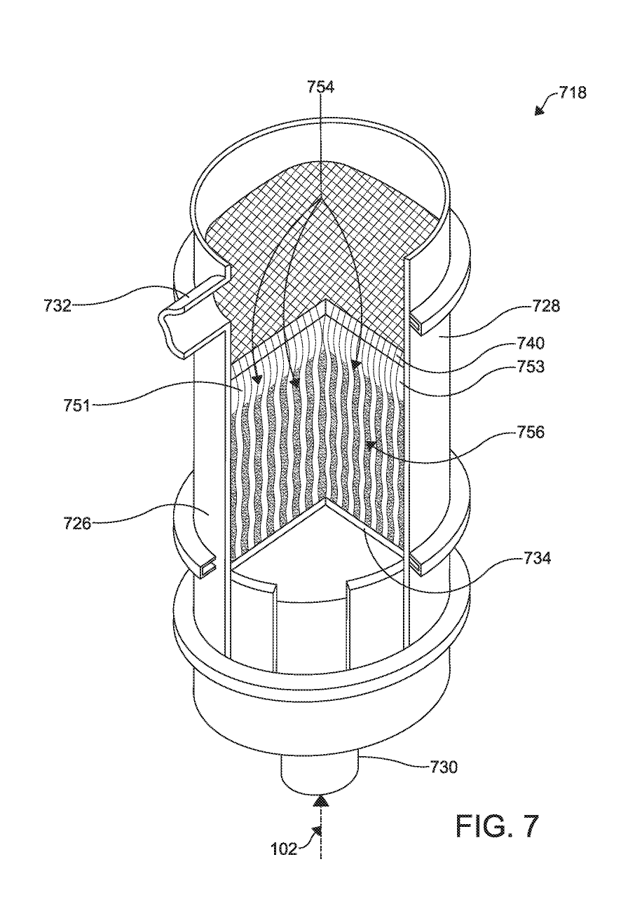

Referring to FIG. 7, following the application of the blocking agent 756 and pressurized air stream 754 or other particulate displacement mechanisms, the blocking agent 756 may be removed. The pressurized air stream 754 entering at the second axial end 728 towards the first axial end 726 be used to force the particulate from the porous substrate 746 of the filter medium 734. For example, where the blocking agent 756 may have been applied at the outlet channels 753 of the filter medium 734, the blocking agent 756 remaining in the outlet channels 753 after the displacement of the particulate from the inlet channels 751 may be removed using an effluent flush of the DPF 718 in the upright vertical position. An effluent flush may include water. Once the blocking agent 756 is removed, the DPF 718 has been vacated and renewed for new use collecting particulate matter in an engine exhaust stream 102 entering at the filter inlet 730 and exiting through the filter outlet 732. Methods of blocking agent removal may depend upon the appropriate blocking agent 756 applied to the DPF 718.

In an aspect, the blocking agent 756 to be removed may be a solid media. Removal of a solid media blocking agent 756 may depend upon the nature of solubility of the solid media. In one example, the blocking agent 756 may include a water soluble solid media. Water soluble may refer to the capacity of the solid media to dissolve in water or to form a homogenous mixture in an aqueous medium. Where the blocking agent 756 may comprise a water soluble solid media, the blocking agent 756 may be removed from the DPF 718 using a water flush. In a water flush, water may be caused to flow through the DPF 718 thereby dissolving the water soluble solid media. An exemplary, but non-limiting, water soluble solid media may include sodium bicarbonate, commonly baking soda. In a further example, the blocking agent 756 may include a non-water soluble solid media such as sand, glass beads, and steel shot. Where a non-water soluble solid media is introduced into the outlet channels of the filter medium, the non-water soluble solid media may be removed by inverting the DPF 718 so that the second axial end 728 is oriented downwards in the direction of gravity. In this orientation, the solid media may readily flow out of the outlet channels 753 of the filter medium 734.

In one aspect, the blocking agent 756 may be a solid media including soot. As noted above, soot may be a suitable blocking agent 756 owing to its relatively larger particle size rendering the filter medium 734 non-permeable. In one example, the blocking-agent-removal of a soot blocking agent 756 may include burning the soot off of the filter medium 734 using an appropriate external heat source. The heat source may be configured to provide temperatures high enough to combust the blocking agent 756 without damaging the porous substrate 746 of the filter medium 734.

In another specific aspect, the blocking agent 756 to be removed may include a viscous material. Removal of a viscous blocking agent 756 may include the application of a material configured to reduce viscosity. The application of a material configured to reduce the viscosity of the blocking agent 756 may provide for the blocking agent 756 to be flushed out of the filter medium 734 for example using an effluent. In one example where the viscous blocking agent 756 may include shellac, the material configured to reduce the viscosity of the blocking agent 756 may be a lacquer solvent, such as paint thinner.

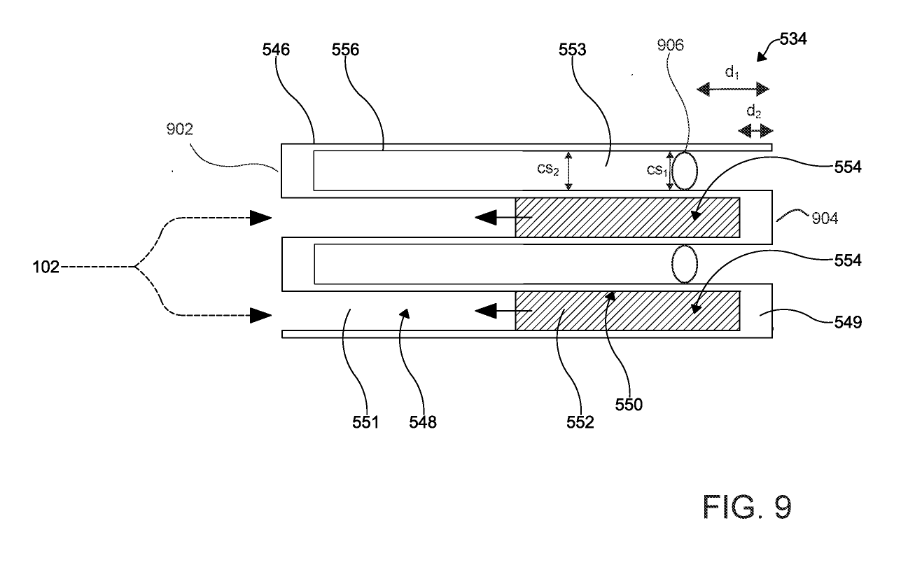

Another exemplary aspect of a method for removing particulate 552 build-up from a DPF 518 is exemplified in the illustration of a partial cross section of a DPF 518 in FIG. 9 showing channels 548. The channels 548 are axially oriented parallel channels that run the length of the filter medium 540 extending from an exhaust inlet end 902 to an exhaust outlet end 904. The individual channels 548 are separated by semi-permeable channel walls 550. Each channel has a non-permeable wall 549 positioned either at the exhaust inlet end 902 or the exhaust outlet end 904. The positioning of a non-permeable wall 549 at the exhaust outlet end 904 of a channel 548 forms an exhaust inlet channel 551 and the positioning of a non-permeable wall 549 at the exhaust inlet end 902 of a channel 548 forms an exhaust outlet channel 553.

According to the methods disclosed herein, a blocking agent 906 may be disposed within the filter medium 534 of the DPF 518 proximal to the exhaust outlet end 904 of the filter 540. As an example, the blocking agent 906 may be selectively applied to some or all of the exhaust outlet channels 553. That is, the blocking agent 906 may be selectively placed at portions of the filter medium for which there is an increased amount of particulate 552 accumulated in that specific portion of the filter medium 534. The blocking agent 906 may be selectively disposed such that the blocking agent 906 is positioned at a depth d1 within the filter measured from the exhaust outlet end 904 of the filter medium 534. The distance d1 is greater than the distance d2 that the non-permeable wall 549 extends from the exhaust outlet end 904 into the filter medium 534. The difference between d1 and d2 thereby creates space where a pressurized air stream 554 applied to the exhaust outlet side 904 of the filter medium 534 will be forced to pass through the semi-permeable channel wall 550 proximal to the exhaust outlet end 904 of the filter medium 534 and ultimately dislodge a greater amount of particulate 552 which will then flow out of the exhaust inlet end 902 filter medium 534 with the pressurized air stream 554.

In various aspects, the blocking agent 906 may be selected so as to effectively obstruct fluid passage through the filter medium 534. Thus, an exemplary blocking agent 906 according to the methods disclosed herein may include a bead of blocking agent 906 positioned as discussed above in the filter medium 534 of the DPF 518. In one embodiment, the bead of blocking agent 906 may be pressed into position. In such an embodiment, the bead of blocking agent 906 may, for example, be a plastic bead or a cured bead of cyanoacrylate. In another embodiment, the bead of blocking agent 906 may be placed by depositing a liquid bead at the correct location and allowing the bead to solidify prior to administering the pressurized air stream 554. For example, the liquid bead may be a cyanoacrylate material that cures into a hard bead and will remain in place during cleaning of the DPF 518. The liquid bead could alternatively be any equivalent material that sets into a solid and would remain in place under pressure during cleaning.

In a specific aspect, the blocking agent 906 may be a solid media. The solid media may be disposed within the filter medium 534 so as to obstruct passage fluid passage through the filter medium 534. In an aspect, the solid media may have cross-section cs1 that is approximately equal to the cross-section cs2 of the exhaust outlet channel 553 in which it is placed.

In a particular example, after the filter medium 534 has been cleaned, the blocking agent 906 may be removed before putting the DPF 518 back into service. The blocking agent 906 may be removed by applying heat to the filter media in order to cause a shrinking of the cross-section cs1 of the blocking agent 906 such that the blocking agent 906 can then be easily removed by tipping the filter to allow the beads to come out via gravity. Alternatively, air pressure may be applied to the exhaust inlet end 902 to push the blocking agent 906 out of the filter medium 534.

### INDUSTRIAL APPLICABILITY

The disclosure is generally applicable to a method of removing particulate accumulated on a DPF by use of a blocking agent. In general, the method prescribes selective application of the blocking agent at the filter medium of the DPF, the direction of pressurized air through filtering channels of the filter medium to dislodge the particulate, and removal of the blocking agent from the filter medium of the DPF.

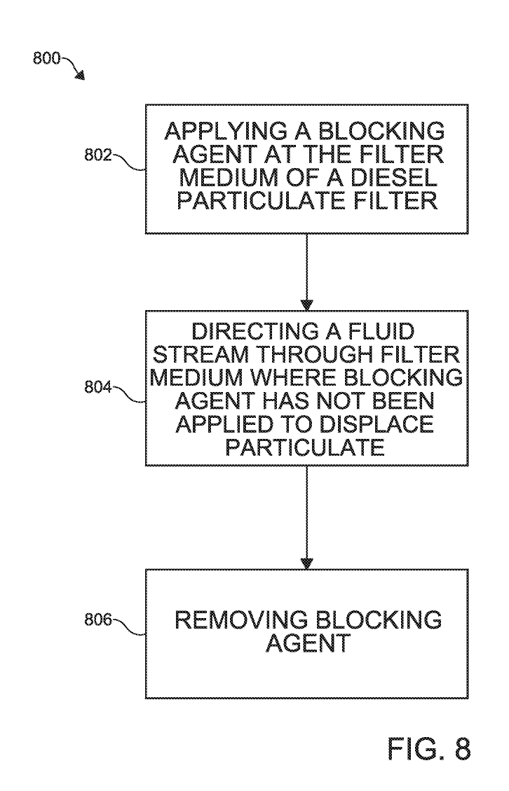

FIG. 8 provides an exemplary method 800 according to an aspect of the present disclosure. In an aspect, one or more steps of the method 800 may be implemented using the DPF 618, 718 of FIGS. 6 and 7. It may be appreciated that there are aspects that do not implement all of the particulate removal procedures depicted in FIGS. 6 and 7, or implement the depicted particulate removal procedures in a different order than is depicted. It should be noted that although FIG. 8 shows a specific order of the steps, it is understood that the order of these steps may differ from what is depicted. Also two or more steps may be performed concurrently or with partial concurrence. Further, it should be noted that some steps are optional and may be omitted. It is understood that all such variations are within the scope of this disclosure.

Step 802 may include applying a blocking agent 656 at the filter medium 634 of the DPF 618. The blocking agent 656 may be applied in a manner so as to effectively prevent fluid passage through the channels 651, 653 of the filter medium 634. The blocking agent 656 may be selectively applied to portions of the filter medium 634 within which particulate 652 has not accumulated.

Step 804 may include directing a fluid stream through the filter wall 640 and the filter medium 634 at portions of the filter medium 634 to which the blocking agent 656 has not been applied. A fluid stream, such as a pressurized air stream 654, may be directed from the second axial end 628 towards the first axial end 626 of the DPF 618 into the portions of the filter medium 534 where the blocking agent 656 has not been applied. The pressurized air stream 654 may be used to dislodge the accumulated particulate 652.

Step 806 may include removing the blocking agent from the filter medium. Referring to FIG. 7, once the particulate is displaced, the blocking agent 756 may be removed. Removal of the blocking agent 756 may depend upon the nature of the blocking agent 756 that has been applied. As an example, a soot blocking agent 756 may be removed via combustion of the blocking agent 756 at the filter medium 734 using an external heat source. As another example, a viscous blocking agent 756 may be removed by the application of a material configured to reduce the viscosity of the viscous blocking agent 756. The blocking agent 756 with its viscosity reduced may then be flushed from the filter medium 734 using an appropriate effluent to provide a vacated DPF 718 for re-use. In a yet further example, a blocking agent 756 including a water soluble solid media may be flushed from the filter medium 734 using a water effluent.

It should be understood that the above description is intended for illustrative purposes only, and is not intended to limit the scope of the disclosure in any way. Thus, those skilled in the art will appreciate that other aspects of the disclosure can be obtained from a study of the drawings, the disclosure and the appended claims.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A method of removing particulate from a diesel particulate filter including a filter medium with an exhaust inlet end and an exhaust outlet end, the method comprising:
disposing a blocking agent within the filter adjacent the exhaust outlet end of the filter medium of the diesel particulate filter;
directing a stream of pressurized fluid into the exhaust outlet end of the diesel particulate filter to force pressurized fluid and the particulate to flow out of the exhaust inlet end; and
removing the blocking agent.

2. The method of claim 1, wherein the filter medium comprises axially oriented, parallel inlet channels and outlet channels defined by permeable channel walls, the inlet channels and outlet channels each alternately having a non-permeable wall disposed at an end thereof and wherein the blocking agent is disposed within the filter media at a depth beyond the non-permeable wall at the exhaust outlet end.

3. The method of claim 2, wherein during disposing of the blocking agent, a liquid bead of blocking agent is placed in at least one channel at the exhaust outlet end and allowed to solidify prior to directing the stream of pressurize fluid.

4. The method of claim 3, wherein the liquid bead of blocking agent is a cyanoacrylate bead.

5. The method of claim 1, wherein the blocking agent has a cross-section approximately equal to a channel cross-section.

6. The method of claim 5, wherein the blocking agent is removed by heating of the blocking agent at the filter medium to shrink the blocking agent cross-section.

7. A method of removing particulate from a diesel particulate filter having an exhaust outlet side, an exhaust inlet side, and a filter medium having axially oriented, parallel exhaust inlet channels and exhaust outlet channels defined by permeable channel walls, the inlet channels and outlet channels each alternately having a non-permeable wall disposed at an end thereof, the method comprising:
inserting a blocking agent into the outlet channels adjacent the outlet side non-permeable wall to direct fluid passage through the filter medium from the outlet side to the inlet side of the filter medium;
directing a stream of pressurized fluid through the outlet side of the filter medium to force the pressurized fluid and the particulate out the inlet side of the filter; and
removing the blocking agent from the outlet channels.

8. The method of claim 7, wherein the inserting of blocking agent into the outlet channels comprises disposing a liquid bead in the outlet channels and allowing the bead to solidify prior to directing the stream of pressurize fluid

9. The method of claim 8 wherein the liquid bead of blocking agent is a cyanoacrylate bead.

10. The method of claim 7, wherein the blocking agent has a cross-section approximately equal to a channel cross-section.

11. The method of claim 10, wherein the blocking agent is removed by heating of the blocking agent at the filter medium to shrink the blocking agent cross-section.
